(19) United States
(12) Patent Application Publication
(10) Pub. No.: US 2007/0169445 A1
(43) Pub. Date: Jul. 26, 2007

(54) Filter flow turbine

(75) Inventors: Allen Buhr Wright, Hope Mills, NC (US); Jorge Antonio Trevino, Friendswood, TX (US)

Correspondence Address: CROWELL & MORING LLP;INTELLECTUAL PROPERTY GROUP, P.O. BOX 14300, WASHINGTON, DC, 20044-4300, US

(73) Assignee: Arvin Technologies, Inc.

(21) Appl. No.: 11/339,458

(22) Filed: Jan. 25, 2006

(51) Int. Cl. B01D 50/00

(52) U.S. Cl. 55/337

(57) ABSTRACT

A filter includes a housing providing an interior. The housing includes an outlet and an inlet arranged radially outwardly from the outlet. A filter element assembly is arranged within the interior and includes a filter media for filtering fluid within the filter. A turbine includes fins arranged axially beneath the inlet within the interior for centrifugally separating debris from the fluid. The turbine is provided by an integrated end disc, end cap and fins, in one example, molded from plastic. Another end disc or end cap is arranged opposite of the turbine and supports another end of the filter media. The end cap includes a circumferential wall that extends outwardly adjacent to the housing. Recesses are provided in the circumferential wall to permit fluid communication between an inlet side of the filter element assembly and a cavity arranged between the end cap and a bottom of the housing. The heavy debris passes through the recesses and collects in the cavity as the debris is centrifugally separated from the fluid.

### BACKGROUND OF THE INVENTION

This invention relates to flow turbines suitable use in fluid filters, such as oil and fuel filters.

Typically, filters include filter element assemblies that are manufactured using an end disc, and where required, a separate element cap to hold a filter media. The filter element assembly is arranged within a housing. Some filters are made with add-on vanes or a spin ring to impart a spin to the fluid being filtered in order to centrifugally separate out heavy particles. To date, these add-on fins have been arranged between an outside of the filter element assembly and an inside wall of the housing. This configuration typically results in an undesired increased restriction in fluid flow through the filter.

Thus, the benefit of spinning the fluid to remove heavy particles, conflicts with the problem of fluid restriction. Another disadvantage is that the end cap, end disc and spin ring must each be formed, cut or molded of metal, paper or plastic and then carefully assembled into the finished filter. Costs are incurred for the materials, handling, inventory, assembly and scheduling of each of these components. Also, scrap is generated due to the handling and assembly of the separate components.

What is needed is a flow turbine that does not significantly increase the flow restriction through the filter. What is also needed is a flow turbine that reduces the number of components and simplifies assembly of the filter.

### SUMMARY OF THE INVENTION

A filter according to the present invention includes a housing providing an interior. The housing includes an outlet and an inlet arranged radially outwardly from the outlet. A filter element assembly is arranged within the interior and includes a filter media for filtering fluid within the filter. A turbine includes fins arranged axially beneath the inlet, and within the interior for centrifugally separating debris from the fluid. The turbine is provided by an integrated end disc, end cap and fins, in one example, molded from plastic. The fins are arranged axially beneath the inlet in one example, to provide a simplified compact design without restricting flow significantly.

Another end disc or end cap is arranged opposite of the turbine and supports another end of the filter media. The end cap includes a circumferential wall that extends outwardly adjacent to the housing. Recesses are provided in the circumferential wall to permit fluid communication between an inlet side of the filter element assembly and a cavity arranged between the end cap and a bottom of the housing. The heavier debris passes through the recesses and collects in the cavity as the debris is centrifugally separated from the fluid.

Accordingly, the inventive filter provides an improved turbine that reduces the flow restriction experienced with prior art spin rings. Additionally, the inventive turbine reduces the number of components and simplifies assembly.

The various features and advantages of this invention will become apparent to those skilled in the art from the following detailed description of the currently preferred embodiment. The drawings that accompany the detailed description can be briefly described as follows.

### BRIEF DESCRIPTION OF THE DRAWINGS

FIG. 1 is a cross-sectional view of an oil filter according to the present invention.

FIG. 2 is a perspective view of a filter element assembly according to the present invention.

FIG. 3 is a perspective view of a variation of a first end disc shown in FIG. 2.

FIG. 4 is a perspective view of a second end disc as shown in FIG. 2.

FIG. 5 is a perspective view of another example second end disc.

### DETAILED DESCRIPTION OF THE PREFERRED EMBODIMENT

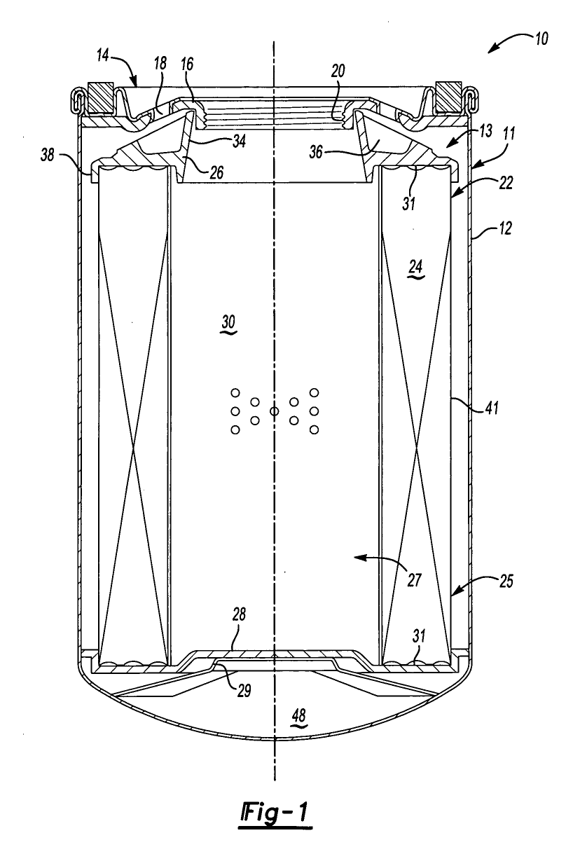

A filter 10 is shown in FIG. 1. Although an oil filter is shown in FIG. 1, the present invention is suitable for other fluid filter applications such as fuel filters. The filter 10 includes a housing 11 having a case 12 and a retainer 14 providing an interior 13. A tapping plate 16 is secured to the housing 11 with the retainer 14, as is well known in the art. The tapping plate 16 typically provides multiple holes 18 arranged circumferentially around a central aperture 20. The central aperture 20 is typically threaded and provides an outlet. The multiple holes 18 provide an inlet.

A filter element assembly 22 is arranged within the interior 13. The filter element assembly 22 includes a filter media 24 arranged between first and second end discs 26 and 28. Typically, the filter media 24 is a pleated paper element. The filter element assembly 22 includes inlet and outlet sides 25 and 27. A center tube 30 is typically arranged on the outlet side 27 to support the filter media 24 and prevent it from collapsing under the pressure of fluid passing through the filter media 24. A perforated, metallic center tube 30 is schematically shown in FIG. 1. However, it should be understood that any or no center tube may be used with the filter 10.

The first and second end discs 26 and 28 include seats 31 that support the filter media 24, which is secured to the seats 31 with adhesive. A guide 29 is arranged between the second end disc 28 and a bottom of the case 12 to position and retain the filter element assembly 22 within the interior 13 in a desired manner.

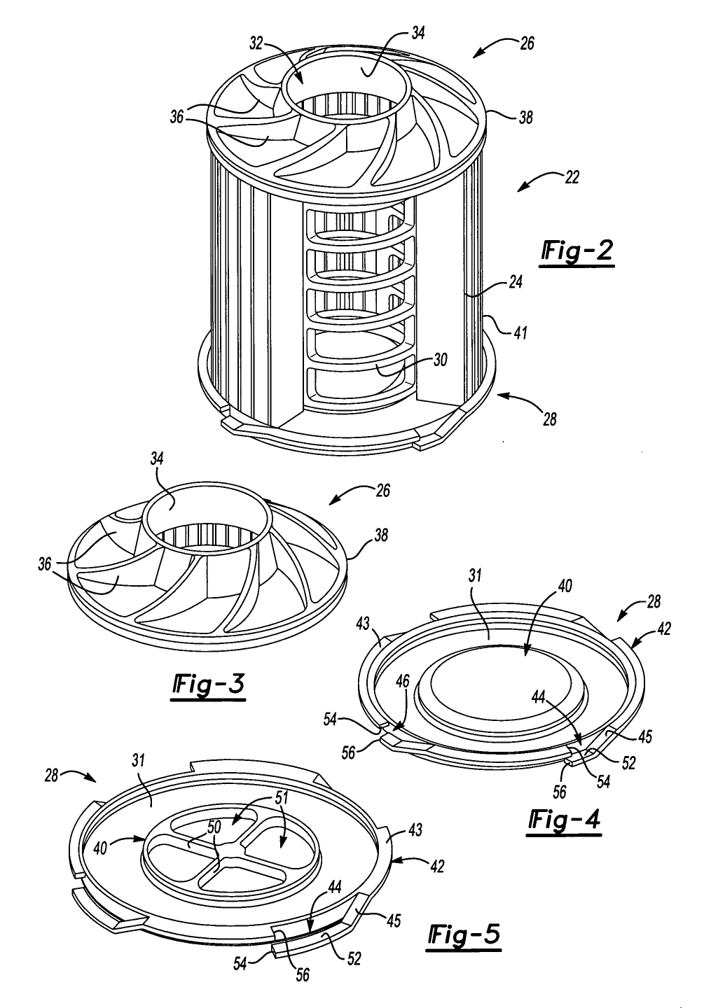

An inventive turbine is provided by the first end disc 26 near the inlet. The prior art separate end disc and element cap are integrated in the inventive first end disc. An anti-drain back valve and a relief valve are not shown in FIG. 1 for clarity but may be used if desired. The first end disc 26 includes a cylindrical wall 34 that extends from a location near the seat 31 to the tapping plate 16. The cylindrical wall 34 can be any desired height, and may be taller than shown in FIG. 2, as shown in FIG. 3.

Multiple fins 36, best shown in FIG. 2, extend downwardly from the cylindrical wall 34 toward a periphery 38 of the first end disc 26. The fins 36 are curved to induce a vortex in the fluid that is sufficient to centrifugally separate debris in the fluid. The fins 36 are arranged axially beneath the multiple holes 18, unlike the prior art spin ring which is arranged between the filter element assembly 22 and the case 12. That is, the prior art spin ring is arranged at a radial location between the end disc and the housing.

The second end disc 28 is configured to trap the separated debris in a cavity 48 arranged between the second end disc 28 and the bottom of the case 12, as shown in FIG. 1. The cavity 48 provides a quiescent area for the debris to collect. Isolating the larger debris from the filter media 24 improves the efficiency and life of the filter 10.

Referring to FIG. 4, the second end disc includes a protrusion 40 that, in part, defines an inner side of the seat 31. A circumferential wall 42 extends from near the seat 31 adjacent to the case 12, which is best shown in FIG. 1. Returning to FIG. 4, the circumferential wall 42 includes a surface 43 having recesses 44 that provide breaks in the surface 43 to permit fluid communication between the inlet side 25 and the cavity 48. The recesses 44 are provided by a sloped portion 45 that extends to a flat portion 52. A first edge 54 provided by the surface 43 and a second edge 56 provided by the flat portion 52 are offset from one another to provide an opening 46 through which debris passes, from the inlet side 25 into the cavity 48.

Referring to FIG. 5, a second end disc 28 is shown for use with a bypass valve, which are well known in the art. The second end disc 28 includes apertures 51 in the protrusion 40 to enable an open bypass valve to fluidly communicate with the outlet side 27.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

What is claimed is:

1. A filter comprising:
a housing providing an interior, and including an outlet and an inlet arranged radially outwardly from the outlet;
a filter element assembly arranged within the interior and including a filter media; and
a turbine including fins arranged axially beneath the inlet and within the interior for centrifugally separating debris from a fluid.

2. The filter according to claim 1, wherein the turbine provides an end disc including a seat and an end of the filter media is supported by the seat, the fins arranged on the turbine opposite the seat.

3. The filter according to claim 2, wherein the turbine includes a generally cylindrical wall transverse to the seat, and the fins extend from the generally cylindrical wall downwardly toward a periphery of the turbine.

4. The filter according to claim 3, wherein the fins are curved to induce a vortex on the fluid.

5. The filter according to claim 3, wherein the generally cylindrical wall extends axially from the seat toward a tapping plate of the housing, the tapping plate providing the outlet and the inlet.

6. The filter according to claim 2, wherein the filter element includes a second end disc opposite the end disc and supporting another end of the filter media, the second end disc extending radially outwardly from the filter media and adjacent to the housing, the second end disc having recesses in fluid communication with a cavity between the second end disc and a bottom of the housing.

7. The filter according to claim 6, wherein the second end disc includes a circumferential wall with the recesses providing a break in the circumferential wall.

8. A filter element assembly comprising:
a filter media extending along an axis and having an outer circumference; and
a turbine having fins at least partially within the outer circumferential and spaced axially from and an end of the filter media.

9. The filter element assembly according to claim 8, wherein the turbine provides an end disc including a seat and an end of the filter media is supported by the seat, the fins arranged on the turbine opposite the seat.

10. The filter element assembly according to claim 9, wherein the turbine includes a generally cylindrical wall transverse to the seat, and the fins extend from the generally cylindrical wall downwardly toward a periphery of the turbine.

11. The filter element assembly according to claim 9, wherein the fins are curved in a radial direction.

12. The filter element assembly according to claim 8, wherein the turbine is plastic.

13. A filter element assembly comprising:
a filter media having an outer circumference; and
an end cap supporting the filter media and including a circumferential wall extending radially outwardly beyond the outer circumference, the circumferential wall including a surface with a recess providing a break in the surface.

14. The filter element assembly according to claim 13, wherein the end cap is plastic.

15. The filter element assembly according to claim 13, wherein the end cap includes a protrusion adjacent to a seat that supports an end of the filter media.

16. The filter element assembly according to claim 13, wherein the recess includes a portion having a first edge offset from a second edge provided by the surface forming an opening.

17. The filter media assembly according to claim 16, wherein the portion includes a sloped portion and an adjoining generally flat portion that provides the first edge.
